(19) United States
(12) Patent Application Publication
(10) Pub. No.: US 2017/0299472 A9
(43) Pub. Date: Oct. 19, 2017

(54) METHOD FOR PREDICTING A PLANT HEALTH STATUS, SYSTEM FOR PREDICTING A PLANT HEALTH STATUS, AND A COMPUTER-READABLE STORAGE MEDIUM IN WHICH A PROGRAM FOR PERFORMING THE METHOD IS STORED

(71) Applicant: BNF TECHNOLOGY INC., Daejeon (KR)

(72) Inventor: Ho Joon SEO, Daejeon (KR)

(73) Assignee: BNF TECHNOLOGY INC., Daejeon (KR)

(21) Appl. No.: 14/287,548

(22) Filed: May 27, 2014

(30) Foreign Application Priority Data
Aug. 29, 2013 (KR) 10-2013-0102961

(51) Int. Cl. G01M 99/00; G05B 23/02

(52) U.S. Cl. CPC G01M 99/00; G05B 23/0227

(57) ABSTRACT

A method for predicting a plant health status, a system for predicting a plant health status, and a computer-readable storage medium in which a program for performing the method is stored are disclosed. In some embodiments, the method includes a step in which a first difference between a historical dataset and an input value is calculated, a step in which a weight based on a precision index and the calculated first difference is determined, a step in which a prediction value is determined by applying the weight to the historical data set, and a step in which a second difference between the prediction value and the input value is calculated, wherein the precision index is selected from a plurality of precision index candidates.

### CROSS-REFERENCE TO RELATED APPLICATION

This application claims the priority of the Korean Patent Application No. 10-2014-0102961 filed on Feb. 12, 2014 in the Korean Intellectual Property Office, and all the benefits accruing therefrom under 35 U.S.C. §119. The contents of the above-listed patent application in their entirety are herein incorporated by reference.

### TECHNICAL FIELD

The present disclosure relates in some embodiments to a method and a system for predicting a health status of a plant and a computer-readable storage medium in which a program to perform the method is stored, and, to a method and a system for predicting a health status of plant for optimizing precision dynamically based on input values.

Generally, there are various kinds of equipment in an industry plant, and a system for monitoring them is introduced so as to take actions before a serious problem occurs.

For an example, a plant consists of such as a turbine and its auxiliary equipment system, a generator and its auxiliary equipment system, a boiler and its auxiliary equipment system, a main water supply system, a condensate water system, a fuel supply system, a cooling water system, a circulating water system, and an auxiliary steam system. A turbine and its auxiliary equipment system consists of a high pressure turbine, a medium pressure turbine, a low pressure turbine, a main steam control valve system, a main steam blocking valve system, a turbine speed control system, a turbine steam bleeding system, a turbine bearing lubrication system, etc., and each of those systems consists of unit apparatuses or specific component systems. Those apparatuses are organically linked with one another to generate electricity. A warning is alarmed if performance of an apparatus or the whole plant declines, or an apparatus or the whole plant is forced to stop if a danger is detected.

Thus, in order to produce an intended product for a plant, it is necessary to monitor each kind of equipment's operating status in real time so that their conditions and performance are optimized.

### SUMMARY

In accordance with some embodiments, there is provided a method for predicting a plant health status, the method comprising a step in which a first difference between a historical data set and an input value is calculated, a step in which a weight based on a precision index and the calculated first difference is determined, a step in which a prediction is determined by applying the weight to the historical data set, and a step in which a second difference between the prediction and the input value is calculated, wherein the precision index is selected from a plurality of precision index candidates.

In accordance with some embodiments, there is provided a system for predicting a plant health status, the system comprising a first operation unit that calculates a first difference between a historical data set and an input value, a weight selection unit that determines a weight based on a precision index and the calculated first difference, a prediction value computation unit that determines a prediction value by applying the weight to the historical data set, a second operation unit that calculates a second difference between the prediction value and the input value, and a precision index management unit that manages a plurality of precision index candidates, wherein the precision index is selected from a plurality of precision index candidates.

In accordance with some embodiments, there is provided a non-transitory computer-readable storage medium in which a program for performing a method for predicting a plant health status, comprising a step in which a first difference between a historical data set and an input value is calculated, a step in which a weight based on a precision index and the first difference is determined, a step in which a prediction is determined by applying the weight to the historical data set, and a step in which a second difference between the prediction and the input value is calculated, wherein the precision index is selected from a plurality of precision index candidates.

### BRIEF DESCRIPTION OF THE DRAWINGS

FIG. 1 is a flow chart of a method for predicting a health status of a plant according to some embodiments.

FIG. 2 is a schematic drawing that shows a process of generating a historical data set used for predicting a health status in FIG. 1.

FIG. 3 is a schematic graph that illustrates a weighted graph applied to a method for predicting a health status of a plant in FIG. 1.

FIG. 4 is a schematic graph that illustrates a weighted graph applied to a method for predicting a health status of a plant in FIG. 1.

FIG. 5 is a schematic graph that illustrates a method for determining precision index applied to a method for predicting a health status of a plant in FIG. 1.

FIG. 6 is a schematic graph that illustrates a method for determining precision index applied to a method for predicting a health status of a plant in FIG. 1.

FIG. 7 is a block diagram illustrates a composition of a method for predicting a plant health status.

### DETAILED DESCRIPTION

A method for predicting a plant health status, and a computer-readable storage medium in which a program for performing the method is stored will be described more fully hereinafter with reference to the accompanying drawing, in which some embodiments are shown. Advantages and features of some embodiments accomplishing the same are hereafter detailed with reference to the accompanying drawings. The method for predicting a plant health status, and the computer-readable storage medium in which a program for performing the method is stored are embodied in different forms and should not be construed as limited to the embodiments set forth herein. Rather, these embodiments are provided so that this disclosure will be thorough and complete, and will fully convey the scope of the electrical brain stimulation system to those skilled in the art. The same reference numbers indicate the same component throughout the specification.

Unless defined otherwise, all technical and scientific terms used herein have the same meaning as commonly understood by one of ordinary skill in the art to which this application belongs. It is noted that the use of any and all examples, or exemplary terms provided herein is intended merely to better illuminate the electrical brain stimulation system and is not a limitation on the scope of the electrical brain stimulation system unless otherwise specified. Further, unless defined otherwise, all terms defined in generally used dictionaries may not be overly interpreted.

The use of the terms “a” and “an” and “the” and similar referents in the context of describing the electrical brain stimulation system (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Also, the term “applying” is construed to, but is not limited to, cover the product of vectors.

A detailed description of the electrical brain stimulation system is hereafter presented with reference to the accompanying drawings.

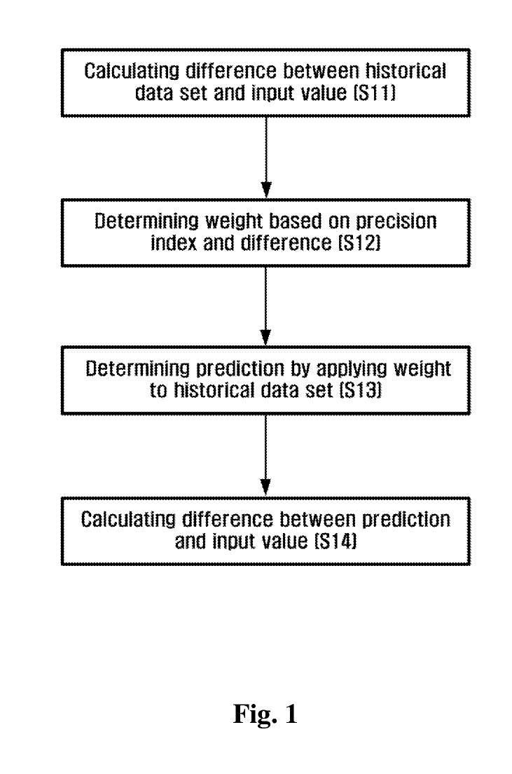

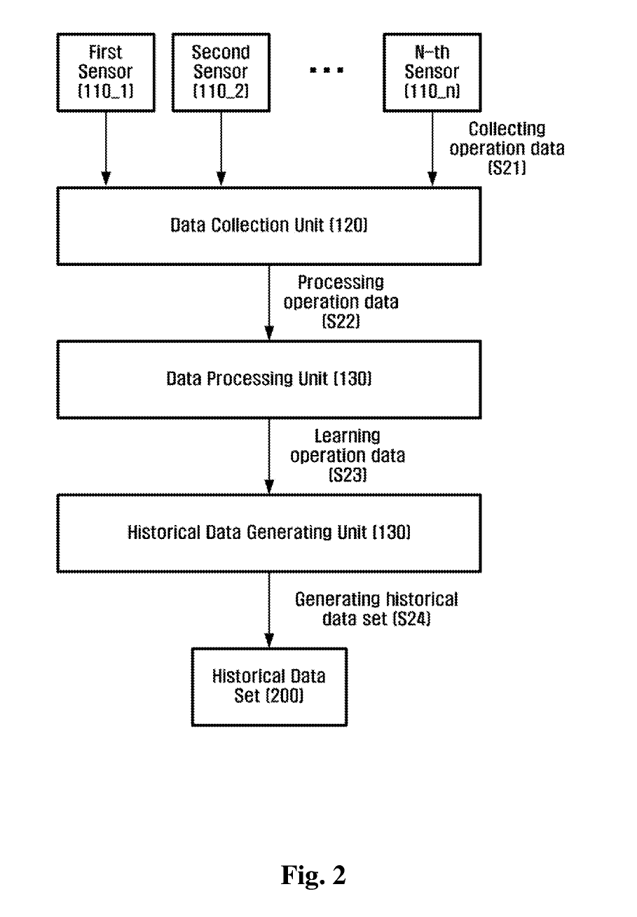

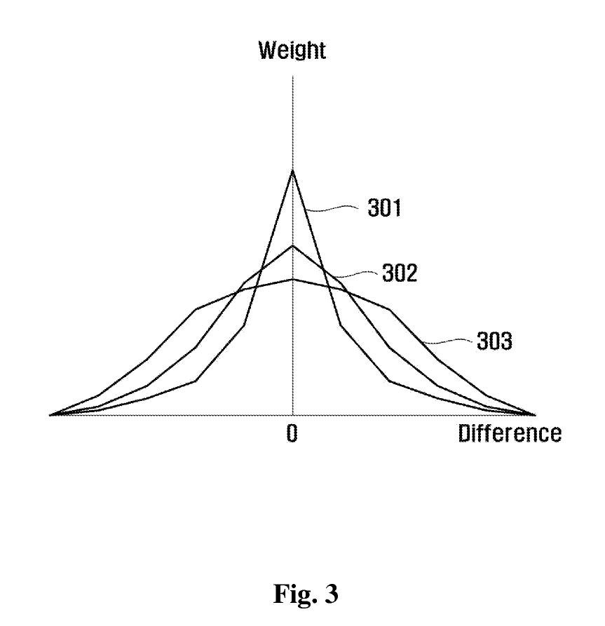

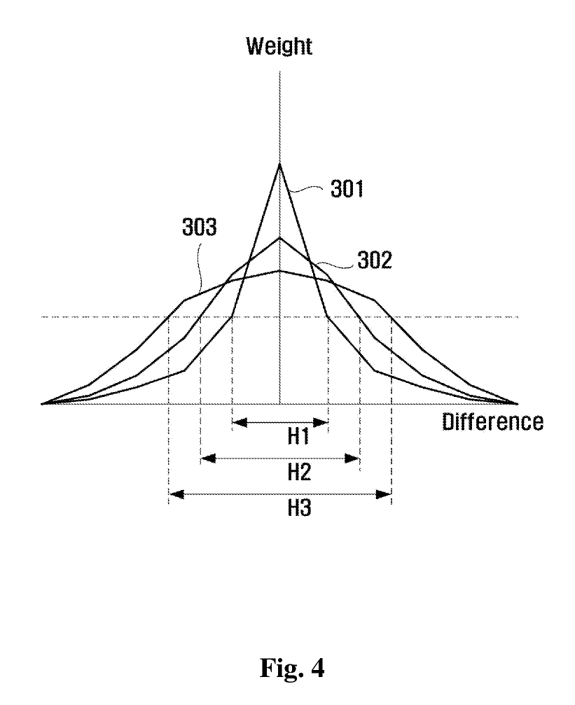

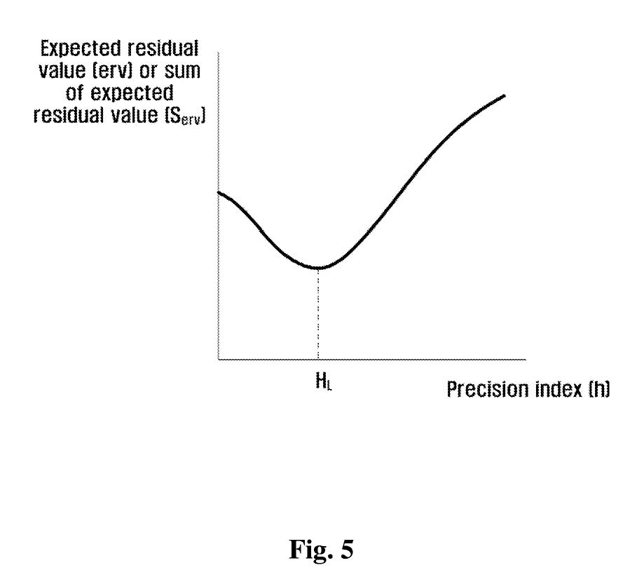

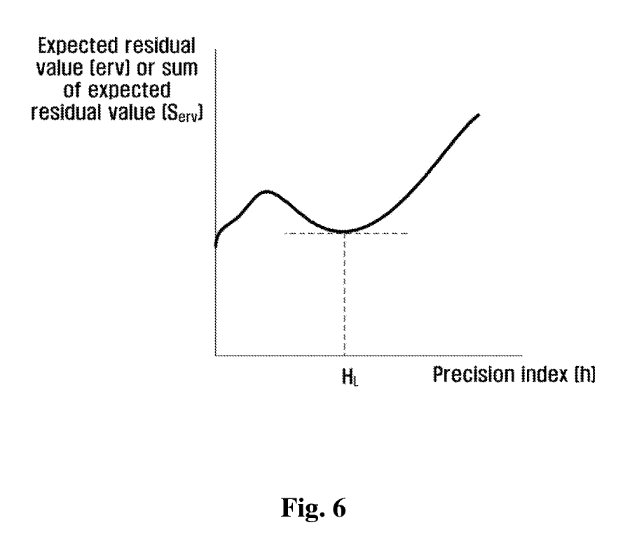

FIG. 1 is a flow chart of a method for predicting a health status of a plant according to some embodiments. FIG. 2 is a schematic drawing that shows a process of generating a historical data set used for predicting a health status in FIG. 1. FIG. 3 and FIG. 4 are schematic graphs that illustrate a weighted graph applied to a method for predicting a health status of a plant in FIG. 1. FIG. 5 and FIG. 6 are schematic graphs that illustrate a method for determining precision index applied to a method for predicting a health status of a plant in FIG. 1.

As shown in FIG. 1, a method for predicting a plant health status includes a step in which a first difference between a historical data set and an input value is calculated, a step in which a weight based on a precision index and the first difference is determined, a step in which a prediction is determined by applying the weight to the historical data set, and a step in which a second difference between the prediction and the input value is calculated, wherein the precision index is selected from a plurality of precision index candidates. For an example, an application of a weight to a historical data set is performed by the product of the weight and the historical data set. The weight and the historical data set can be a vector. The method for predicting the plant health status is performed by a prediction apparatus. The prediction apparatus includes one or more physical, actual storage devices to store and execute the method for predicting the plant health state. Examples of physical, actual storage devices includes, but are not limited to, magnetic media such as, a hard disk, a floppy disk, and a magnetic tape, optical media such as a CD-ROM and a DVD, magneto-optical media such as a floppy disk, and a hardware device configured especially to store and execute a program, such as a ROM, a RAM, a solid state drive, and a flash memory. The controlling module 20 is implemented by one or more programmed processors and/or application-specific integrated circuits (ASICs).

As shown in FIG. 1 and FIG. 2, a first difference between a historical data set and an input value is calculated as presented in S11. In many cases, a plurality of modules in a plant facility is organically combined to affect each other. Thus, a plant facility includes a plurality of modules and a plurality of sensors 110 that monitors the plurality of sensors, and it collects operation data every unit time from the plurality of sensors. For an example, a first sensor 110_1 detects a flux of a boiler tube, and a second sensor 110_2 detects a temperature of cooling water. Each sensor 110 collects data by detecting sensor values at intervals of such as every a half or one second.

A plurality of operation data collected such is received to a data collection unit 120 so that a status of a plant is monitored. A data collection unit 120 is connected with a plurality of sensors 110 to receive and manage various operation data. A data collection 120 can be located at, but is not limited to, the inside of a plant facility, or it is located at a control center or a control room, etc. separately arranged to manage a plurality of plants. A data collecting unit 120 receives all operation data collected from a plant or a plurality of plants, or operation data of a plant is sent to a plurality of data collection unit 120 and is processed.

Operation data received at a data collection unit is delivered to a data processing unit 130, and the operation data is processed at the data processing unit 130. Each detected signal that constitutes operation data is a measured result at a separated module and therefore its range such as a unit they represent is not always the same. Thus, a first data for correcting a plurality of detected signals to the same range, determining a correlation between each detected signal, grouping detected signals that show a similar pattern and thus making an estimate model learn them, and a second data for monitoring a real time status of a plant and predicting a status are generated. The first data forms a historical data set 200, and the second data forms an input value for calculating a difference between the historical data set 200 and a first difference.

Operation data processed at a data processing unit 130 is sent to a historical data generating unit 130, a historical data set 200 is formed based on the operation data at the historical data generating unit 130, and the historical data set 200 forms a predicting model for monitoring and predicting a health status of a plant.

As shown in S12 in FIG. 1, a first difference is calculated between a historical data set 200 formed in this wise and an input value, and a weight is determined based on the first difference and a precision index of a predicting model.

In another some embodiments, a first difference between a historical data set 200 and an input value means, but is not limited to, a distance in an n-dimensional space between the historical data set 200 and the input value.

A historical data set 200 generated based on the past operation data does not include all physical operation data for every situation, so a corresponding value does not exist regarding a specific input value.

According to an embodiment of a method for predicting a plant health status, whether the current plant status is normal is determined by contrasting input values that are collected in real time, and a future plant status is predicted according to a tendency of input values. That is, a plant status is determined based on the difference between an input value and a corresponding comparison value extracted from a historical data set 200.

In a case where a precision of a predicting model is fixed as it was in the existing method, an error occurs while a comparison value are extracted or a wrong result is drawn if an input value not matching with the historical data set 200 is received. Thus, a method for predicting a plant health status according to the embodiment flexibly determines a precision index of a predicting model according to an input value so that it enhances adaptability and precision of the predicting model.

As shown in FIG. 3 and FIG. 4, a relation between a weight-difference graph applied to a historical data set 200 and a precision index of a predicting model is presented. A weight is differently assigned according to the difference between a historical data set 200 and an input value. For an example, in the case where the difference is zero, that is, a same comparison value is contained in the historical data set 200, the corresponding comparison value is assigned the highest weight as shown in the graph. On the other hand, a lower weight is assigned as the difference between input values increases.

In the process above, ways to assign a weight differ to each other. For an example, a first weighted graph 301 shows the steepest gradient, assigns a comparatively high weight if the difference is zero, and sets a precipitously low weight as the difference increases. That is, a first weighted graph 301 has a high precision index, and its expandability for monitoring and predicting against an input value of a plant is comparatively low. On the other hand, in the case of a third weighted graph 303, when the difference is zero, a comparatively low weight is assigned and a gradual weight is set up even if the difference increases. That is, a third weighted graph 303 has a low precision index, whereas its expandability for monitoring and predicting against an input value of a plant is comparatively high. In other words, a first weighted graph is hard to determine a prediction if a value different from the existing operation data is input, whereas a third weighted graph 303 determines a prediction even if a precision is low.

Likewise, a weight applied to a historical data set 200 is determined based on a precision index dynamically determined according to a received input value. For this purpose, a precision index is selected from a plurality of precision index candidates.

As shown in FIG. 4, a precision index is determined as the bandwidth on a baseline of a predicting model based on a specifically weighted fiducial line of a predicting model. A precision index of a first weighted graph 301 is determined as H1, and precision indices of a second and a third weighted graph 302, 303 are determined as H2 and H3 respectively.

FIGS. 5 and 6 show a more specific method for determining a precision index.

In some embodiments, a step S12 in which a weight is determined includes a step in which a correlation between a group precision index candidates and an expected second difference is presented as a relation graph, and in which a precision index is determined from a group of precision index candidates at a point at which a gradient of the relation graph reaches a predetermined value.

A second difference, as will be described later, is the difference between an input value and a prediction deduced from a finally determined weight. As the second difference increases, an error or fluctuation between the prediction and the input value gets larger, and this means the instability of a plant system increases.

On the other hand, an expected second difference, unlike a final second difference, is determined as an expected residual value of an expected prediction deduced from a historical data set 200 to which an expected weight is applied, by determining an expected weight based on specific group of precision index candidates. In other words, an expected second difference does not mean a real second difference, but it means an expected residual value based on a group of precision index candidates for the purpose of determining an optimal precision index (H_{L}) against an input value.

A sum of expected second differences is determined as the sum of expected residuals by calculating each expected residual value from a plurality of input value groups collected from a plurality of sensors 110. For an example, in a case in which a plurality of input values belongs to a group, a prediction to each input value that belongs to the group is determined, and based on this, each expected residual value is calculated, and then an expected second difference is determined by adding up a plurality of expected residual values.

In other example embodiment, a sum of expected second differences is determined as the sum of ratios defined as quotients where the expected second differences are divided by each operating range to each input value, and based on a sum of those ratios, a relation graph is deduced and an optimal precision index (H_{L}) is determined. Otherwise, an optimal precision index (H_{L}) is determined based on an expected second difference to a single input value collected at a sensor 110.

In other example embodiment, a step S12 in which a weight is determined includes a step in which a group of precision index candidates is determined as a precision index, based on a correlation between the group of precision index candidates and the expected second differences, when a sum of expected second differences reaches a predetermined value.

As described above, a precision index corresponds to the width on a particular base line on a relation graph.

To determine a corresponding weight of a historical data set 200 to an input value, a precision index is dynamically determined. For this purpose, in Equation 1 below for deducing a weight w, a weight w according to the variation of precision indices h is calculated while a difference d is fixed. Then, a sum of each expected residual value (Sₑᵣᵥ), the difference between an input value and an estimated value that is determined based on the weight w, is determined. After then, an optimal precision index h between a historical data set 200 and the input value is determined based on a graph that shows a relation between the precision index h and the sum (Sₑᵣᵥ) of each expected residual value.

$$w = \frac{1}{\sqrt{2 π {h}^{2}}} {e}^{- ( \frac{{d}^{2}}{{h}^{2}} )}$$

In other words, as shown in FIG. 5, a precision index h is determined as an optimal precision index (H_{L}) at the point at which a sum of expected residual values (Sₑᵣᵥ) is minimal on a relation graph of a precision index h and a sum of expected residual values (Sₑᵣᵥ). Otherwise, as shown in FIG. 6, a precision index h at the point where a gradient of the sum of expected residual values (Sₑᵣᵥ) reaches a predetermined value, e.g., zero, is determined as an optimal precision index (H_{L}).

In other example embodiment, in a step S12 in which a weight is determined, based on a correlation between a group of precision index candidates and a sum of expected residual values (Sₑᵣᵥ), a group of precision index candidates is determined as a precision index at a point where the sum of expected residual values (Sₑᵣᵥ) reaches a predetermined value. In yet another embodiment, based on a correlation between a group of precision index candidates and a sum of expected residual values (Sₑᵣᵥ), a group of precision index candidates is determined as a precision index at a point where the sum of expected residual values (Sₑᵣᵥ) is minimal.

In a step in which a precision index is determined, by applying greater values gradually from the minimum, a correlation between a group of precision index candidates and a sum of expected residual values (Sₑᵣᵥ) is determined.

A method for determining a precision index h using a relation graph of a sum of expected residual values (Sₑᵣᵥ) and a precision index is an example, and thus it is also applied within the extensible range, in some embodiments.

Next, a prediction is determined, as presented in S13, by applying a weight calculated by applying a precision index h determined for a historical data set 200. By using the method above, a precision index h is determined, a weight is calculated by inputting a difference d, and the weights are applied to a historical data set 200.

After then, a tag index is determined by calculating a second difference between a prediction and an input value, e.g., a residual value. Unlike an expected second difference mentioned above, a second difference is a definite value that reflects an optimal precision index h for calculation. Based on such tag index, a present status of a plant is monitored, and a time when an error is expected to occur by additional information such as a tendency of tag indices is calculated. In this process, for an example, a method for time series analysis and prediction by using Autoregressive Conditional Heteroskedasticity (ARCH) is applied, but the process is not limited to this method, and various algorithms such as neuro-fuzzy system that predict time series signals are also used instead of the aforementioned method.

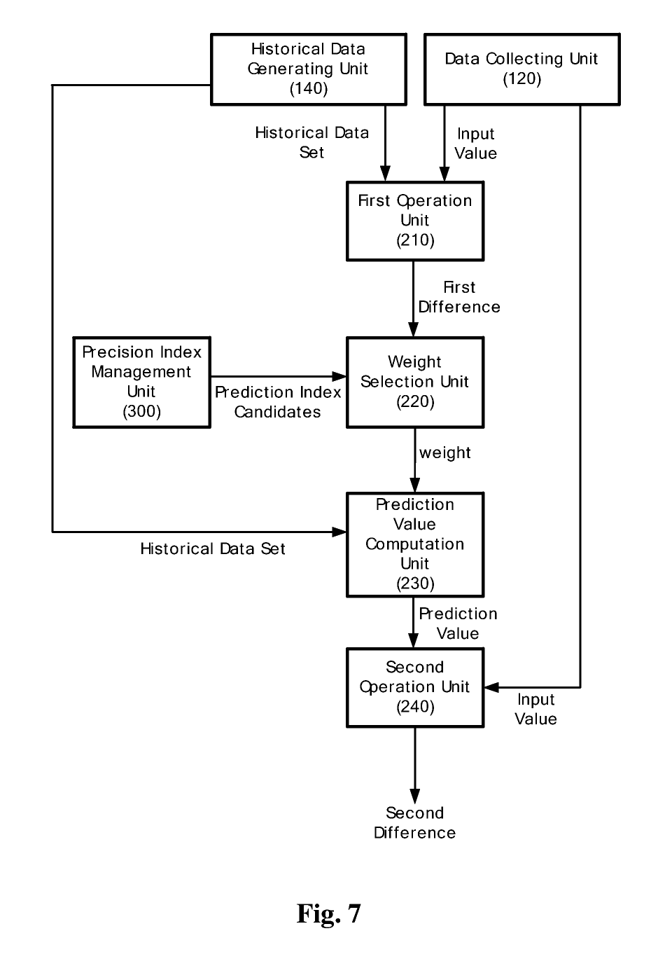

FIG. 7 shows a rough composition of a system for predicting a plant health status that performs a method for predicting a plant health.

A first operation unit 210 calculates a first difference between a received historical data set and an input value. With reference to FIG. 2, if operation data generated from a plurality of sensors 110 are collected and scales between the operation data are corrected, a historical data generating unit 140 generates a historical data set to which a corrected operation data are learned.

After a first difference is calculated, a weight selection unit 220 determines a weight by receiving a plurality of precision index candidates from a precision index management unit 330.

A prediction value computation unit 230 determines a prediction value by applying the weight to the historical data set, and a second operation unit 240 calculates a second difference between a prediction value and an input value and predicts a plant health status.

In the meantime, according to one embodiment, a computer saves readable codes in a computer-readable storage medium and executes them. A computer-readable storage medium includes every kind of storage device where computer-readable data is stored.

A computer-readable code is composed in order to perform steps that execute methods of predicting abnormal data according to one embodiment. A computer-readable code is executed with various programming languages. A functional program, code and code segment for the purpose of executing some embodiments are easily programmed by ordinary engineers in the technical field of the present invention.

A computer-readable storage medium, for example, is read-only memory (ROM), random-access memory (RAM), CD-ROM, magnetic tape, floppy disk, optical data storage device, etc., and it also includes an execution such as a form of carrier transmission, for an example, transmission via the Internet. Furthermore, a computer-readable storage medium is distributed into a computer system connected by a network, and it is also possible that a computer-readable code is stored and executed by a method of distribution.

In concluding the detailed description, those skilled in the art will appreciate that many variations and modifications can be made to the preferred embodiments without substantially departing from the principles of the some embodiments described above. Therefore, the described some embodiments are used in a generic and descriptive sense only and not for purposes of limitation.

We claim:

1. A method for predicting a plant health status, the method comprising:
calculating a first difference between a historical data set and an input value;
determining a weight based on a precision index and the calculated first difference;
determining a prediction value by applying the weight to the historical data set; and
calculating a second difference between the prediction value and the input value,
wherein the precision index is selected from a plurality of precision index candidates.

2. The method of claim 1,
wherein the first difference is a distance in an n-dimensional space between the historical data set and the input value.

3. The method of claim 1,
wherein said determining the weight further comprises:
generating a relation graph of a correlation between the precision index candidates and the second difference;
detecting a precision index candidate at which a gradient of a relation graph reaches a predetermined value, among the precision index candidates; and
setting the detected precision index candidate as the precision index.

4. The method of claim 1,
wherein the precision index corresponds to a width on a base line on the relation graph.

5. The method of claim 1,
wherein said determining the weight further comprises:
detecting a precision index candidate at which the second difference reaches a predetermined value, based on a correlation between the precision index candidates and the second difference, among the precision index candidates; and
setting the detected precision index candidate as the prediction index.

6. The method of claim 5,
wherein said determining the weight further comprises:
detecting a precision index candidate at which the second difference is minimum, based on the correlation between the precision index candidates and the second difference, among the precision index candidates; and
setting the detected precision index candidates as the precision index.

7. The method of claim 6,
wherein said setting a precision index candidate further comprises:
determining the correlation between the precision index candidates and the second difference by sequentially applying values from the smallest to the largest one.

8. The method of claim 1,
wherein said determining the weight further comprises:
determining a weight expectation according to the corresponding precision index candidates;
deducing an expected prediction value by applying the weight expectation;
calculating an expected second difference between the expected prediction value and the input value; and
deducing the weight on the basis of the precision index candidates when the expected second difference is minimum.

9. The method of claim 8,
wherein the input values are plural,
wherein said calculating the expected second difference comprises:
calculating the expected second difference based on the plurality of each input value; and
summing up one or more expected second differences calculated, and
wherein said deducing the weight comprises:
determining the weight based on the precision index candidates when the sum of expected second differences is minimum.

10. A system for predicting a plant health status, the system comprising:
a first operation unit that calculates a first difference between a historical data set and an input value;
a weight selection unit that determines a weight based on a precision index and the calculated first difference;
a prediction value computation unit that determines a prediction value by applying the weight to the historical data set;
a second operation unit that calculates a second difference between the prediction value and the input value; and
a precision index management unit that manages a plurality of precision index candidates, wherein the precision index is selected from a plurality of precision index candidates.

11. The system of claim 10, the system further comprising:
a data collection unit that collects operation data generated from a plurality of modules that constitute a plant;
a data processing unit that corrects scales of the plurality of operation data having different scales so that they are contained within the critical range; and
a historical data generating unit that generates a historical data set based on the corrected operation data.

12. The system of claim 10,
wherein the weight selection unit presents a correlation between the precision index and the second difference as a relation graph, and
the weight selection unit determines a precision index candidate at which a gradient of a relation graph reaches a predetermined value, among the precision index candidates.

13. The system of claim 10,
wherein the weight selection unit determines a precision index candidate as the precision index at which the second difference, based on a correlation between the precision index candidates and the second difference, reaches a predetermined value, among the precision index candidates.

14. The system of claim 13,
wherein the weight selection unit determines a precision index candidate as the precision index at which the second difference, based on a correlation between the precision index candidates and the second difference, reaches a minimum value, among the precision index candidates.

15. The system of claim 10,
wherein the weight selection unit determines an expected weight according to the precision index candidates,
the prediction value computation unit draws an expected prediction value by applying the expected weight,
and the second operation unit calculates an expected second difference, a difference between the expected prediction value and the input value,
wherein it draws the weight based on the precision index candidates at the minimum of the expected second difference.

16. The system of claim 15,
wherein the second operation unit calculates an expected second difference to each value among the plurality of input values and sums them up to determine the sum of expected second differences, and it draws the weight based on the precision index candidates at the minimum of the expected second difference.

17. A non-transitory computer-readable storage medium in which a program for performing a method according to claim 1 is stored.

18. A non-transitory computer-readable storage medium in which a program for performing a method according to claim 16 is stored.
